(19) United States
(12) Patent Application Publication
(10) Pub. No.: US 2014/0161616 A1
(43) Pub. Date: Jun. 12, 2014

(54) MULTI-PIECE BLADE FOR GAS TURBINE ENGINE

(71) Applicant: United Technologies Corporation, (US)

(72) Inventor: Joshua L. Mardis, Palm Beach Gardens, FL (US)

(73) Assignee: UNITED TECHNOLOGIES CORPORATION, Hartford, CT (US)

(21) Appl. No.: 13/711,800

(22) Filed: Dec. 12, 2012

(51) Int. Cl. F01D 11/00; B23P 15/04

(52) U.S. Cl. CPC F01D 11/006; B23P 15/04
USPC 416/193 A; 29/889.7

(57) ABSTRACT

A blade assembly for a gas turbine engine includes a rim seal including leading and trailing edge seal portions joined to one another by an axial portion. The leading and trailing edge seal portions and the axial portion together provide a notch. A blade has a root received in the notch. A rotating stage of a gas turbine engine includes a rotor including a slot. A rim seal includes leading and trailing edge seal portions adjoined to one another by an axial portion and providing a notch. A blade has a root received in the notch. A method of assembling a rotor stage includes inserting a root of a blade into a notch of a rim seal, and sliding the rim seal and blade into a rotor slot.

### BACKGROUND

This disclosure relates to a multi-piece blade for a gas turbine engine. In one example, a two-piece turbine blade is provided.

A gas turbine engine typically includes a fan section, a compressor section, a combustor section and a turbine section. Air entering the compressor section is compressed and delivered into the combustor section where it is mixed with fuel and ignited to generate a high-speed exhaust gas flow. The high-speed exhaust gas flow expands through the turbine section to drive the compressor and the fan section. The compressor section typically includes low and high pressure compressors, and the turbine section includes low and high pressure turbines.

A typical gas engine includes turbine blades that are a single piece. The turbine blade includes a root, which may be a fir-tree shape, received in a correspondingly shaped rotor slot. A platform is supported on the root and provides an aerodynamic inner flow path through the stage. An airfoil extends outward radially from the platform. The platform may provide complex geometries and includes the seal geometry that seals with adjacent structure to the rotor.

It may be desirable to provide at least a portion of the platform that is separate from the airfoil. In one example, a composite platform has been provided, which includes forward and aft portions of the root. The platform includes an aperture through which the airfoil extends. The composite platform entirely surrounds the airfoil.

### SUMMARY

In one exemplary embodiment, a blade assembly for a gas turbine engine includes a rim seal including leading and trailing edge seal portions joined to one another by an axial portion. The leading and trailing edge seal portions and the axial portion together provide a notch. A blade has a root received in the notch.

In a further embodiment of any of the above, the blade has a first circumferential edge and the rim seal has a second circumferential edge. The first and second circumferential edges are aligned with one another in generally the same plane.

In a further embodiment of any of the above, the rim seal and the blade root together provide a root contour.

In a further embodiment of any of the above, the rim seal and the blade together provide a platform defining an inner flow path.

In a further embodiment of any of the above, the blade includes an airfoil extending from the platform. The rim seal does not circumscribe the airfoil.

In a further embodiment of any of the above, the axial portion is arranged beneath the root opposite the airfoil.

In a further embodiment of any of the above, the rim seal and blade are constructed from metallic alloys.

In a further embodiment of any of the above, the axial portion and the leading and trailing edge seal portions are integral with one another.

In a further embodiment of any of the above, the axial portion and the leading and trailing edge seal portions are discrete from and secured to one another.

In another exemplary embodiment, a rotating stage of a gas turbine engine includes a rotor including a slot. A rim seal includes leading and trailing edge seal portions adjoined to one another by an axial portion and providing a notch. A blade has a root received in the notch.

In a further embodiment of any of the above, the rotating stage includes a retainer secured to the rotor configured to maintain the rim seal and blade within the slot.

In a further embodiment of any of the above, the rotating stage includes a seal structure adjacent to the rim seal. The rim seal includes seal geometry interleaved with the seal structure.

In a further embodiment of any of the above, the blade has a first circumferential edge and the rim seal has a second circumferential edge. The first and second circumferential edges are aligned with one another in generally the same plane.

In a further embodiment of any of the above, the rim seal and the blade root together provide a root contour. The rim seal and the blade together provide a platform defining an inner flow path. The blade includes an airfoil extending from the platform. The rim seal does not circumscribe the airfoil and the axial portion is arranged beneath the root opposite the airfoil.

In a further embodiment of any of the above, the axial portion and the leading and trailing edge seal portions are integral with one another.

In a further embodiment of any of the above, the axial portion and the leading and trailing edge seal portions are discrete from and secured to one another.

In another exemplary embodiment, a method of assembling a rotor stage includes inserting a root of a blade into a notch of a rim seal, and sliding the rim seal and blade into a rotor slot.

In a further embodiment of any of the above, the method includes securing a retainer to the rotor to abut the rim seal.

In a further embodiment of any of the above, the method includes arranging a seal geometry of the rim seal in an interleaved relationship with a seal structure.

### BRIEF DESCRIPTION OF THE DRAWINGS

The disclosure can be further understood by reference to the following detailed description when considered in connection with the accompanying drawings wherein:

FIG. 1 schematically illustrates a gas turbine engine embodiment.

FIG. 2 is a perspective view of a portion of a rotor supporting multiple two-pieced turbine blades.

FIG. 3 is a perspective view of an example multi-piece turbine blade.

FIG. 4 is an exploded view depicting a rim seal separate from the turbine blade.

### DETAILED DESCRIPTION

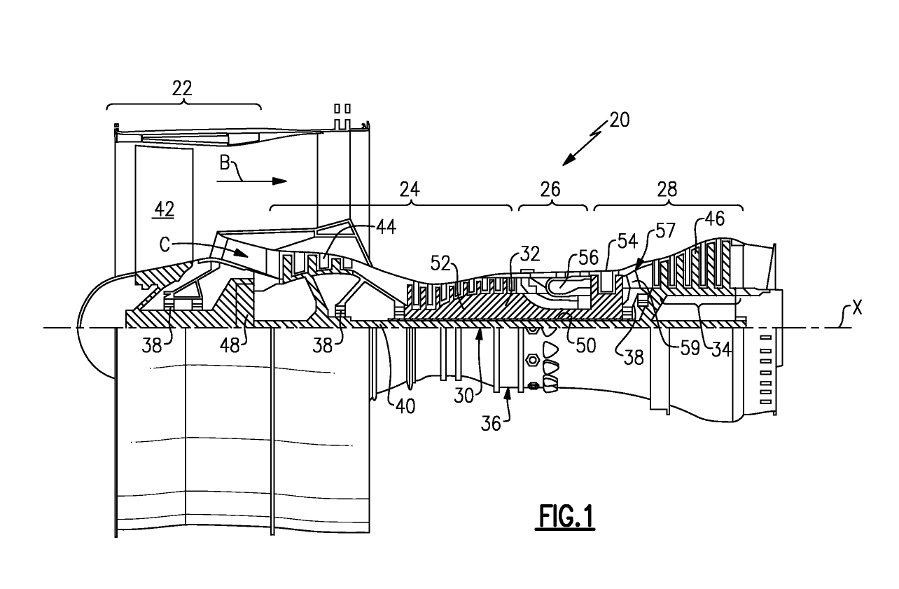

FIG. 1 schematically illustrates an example gas turbine engine 20 that includes a fan section 22, a compressor section 24, a combustor section 26 and a turbine section 28. Alternative engines might include an augmenter section (not shown) among other systems or features. The fan section 22 drives air along a bypass flow path B while the compressor section 24 draws air in along a core flow path C where air is compressed and communicated to a combustor section 26. In the combustor section 26, air is mixed with fuel and ignited to generate a high pressure exhaust gas stream that expands through the turbine section 28 where energy is extracted and utilized to drive the fan section 22 and the compressor section 24.

Although the disclosed non-limiting embodiment depicts a turbofan gas turbine engine, it should be understood that the concepts described herein are not limited to use with turbofans as the teachings may be applied to other types of turbine engines; for example a turbine engine including a three-spool architecture in which three spools concentrically rotate about a common axis and where a low spool enables a low pressure turbine to drive a fan via a gearbox, an intermediate spool that enables an intermediate pressure turbine to drive a first compressor of the compressor section, and a high spool that enables a high pressure turbine to drive a high pressure compressor of the compressor section.

The example engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided.

The low speed spool 30 generally includes an inner shaft 40 that connects a fan 42 and a low pressure (or first) compressor section 44 to a low pressure (or first) turbine section 46. The inner shaft 40 drives the fan 42 through a speed change device, such as a geared architecture 48, to drive the fan 42 at a lower speed than the low speed spool 30. The high-speed spool 32 includes an outer shaft 50 that interconnects a high pressure (or second) compressor section 52 and a high pressure (or second) turbine section 54. The inner shaft 40 and the outer shaft 50 are concentric and rotate via the bearing systems 38 about the engine central longitudinal axis A.

A combustor 56 is arranged between the high pressure compressor 52 and the high pressure turbine 54. In one example, the high pressure turbine 54 includes at least two stages to provide a double stage high pressure turbine 54. In another example, the high pressure turbine 54 includes only a single stage. As used herein, a “high pressure” compressor or turbine experiences a higher pressure than a corresponding “low pressure” compressor or turbine.

The example low pressure turbine 46 has a pressure ratio that is greater than about 5. The pressure ratio of the example low pressure turbine 46 is measured prior to an inlet of the low pressure turbine 46 as related to the pressure measured at the outlet of the low pressure turbine 46 prior to an exhaust nozzle.

A mid-turbine frame 57 of the engine static structure 36 is arranged generally between the high pressure turbine 54 and the low pressure turbine 46. The mid-turbine frame 57 further supports bearing systems 38 in the turbine section 28 as well as setting airflow entering the low pressure turbine 46.

The core airflow C is compressed by the low pressure compressor 44 then by the high pressure compressor 52 mixed with fuel and ignited in the combustor 56 to produce high speed exhaust gases that are then expanded through the high pressure turbine 54 and low pressure turbine 46. The mid-turbine frame 57 includes vanes 59, which are in the core airflow path and function as an inlet guide vane for the low pressure turbine 46. Utilizing the vane 59 of the mid-turbine frame 57 as the inlet guide vane for low pressure turbine 46 decreases the length of the low pressure turbine 46 without increasing the axial length of the mid-turbine frame 57. Reducing or eliminating the number of vanes in the low pressure turbine 46 shortens the axial length of the turbine section 28. Thus, the compactness of the gas turbine engine 20 is increased and a higher power density may be achieved.

The disclosed gas turbine engine 20 in one example is a high-bypass geared aircraft engine. In a further example, the gas turbine engine 20 includes a bypass ratio greater than about six (6), with an example embodiment being greater than about ten (10). The example geared architecture 48 is an epicyclical gear train, such as a planetary gear system, star gear system or other known gear system, with a gear reduction ratio of greater than about 2.3.

In one disclosed embodiment, the gas turbine engine 20 includes a bypass ratio greater than about ten (10:1) and the fan diameter is significantly larger than an outer diameter of the low pressure compressor 44. It should be understood, however, that the above parameters are only exemplary of one embodiment of a gas turbine engine including a geared architecture and that the present disclosure is applicable to other gas turbine engines.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft., with the engine at its best fuel consumption—also known as “bucket cruise Thrust Specific Fuel Consumption (‘TSFC’)”—is the industry standard parameter of pound-mass (lbm) of fuel per hour being burned divided by pound-force (lbf) of thrust the engine produces at that minimum point.

“Low fan pressure ratio” is the pressure ratio across the fan blade alone, without a Fan Exit Guide Vane (“FEGV”) system. The low fan pressure ratio as disclosed herein according to one non-limiting embodiment is less than about 1.50. In another non-limiting embodiment the low fan pressure ratio is less than about 1.45.

“Low corrected fan tip speed” is the actual fan tip speed in ft/sec divided by an industry standard temperature correction of [(Tram ° R)/(518.7° R)]^{0.5}. The “Low corrected fan tip speed”, as disclosed herein according to one non-limiting embodiment, is less than about 1150 ft/second.

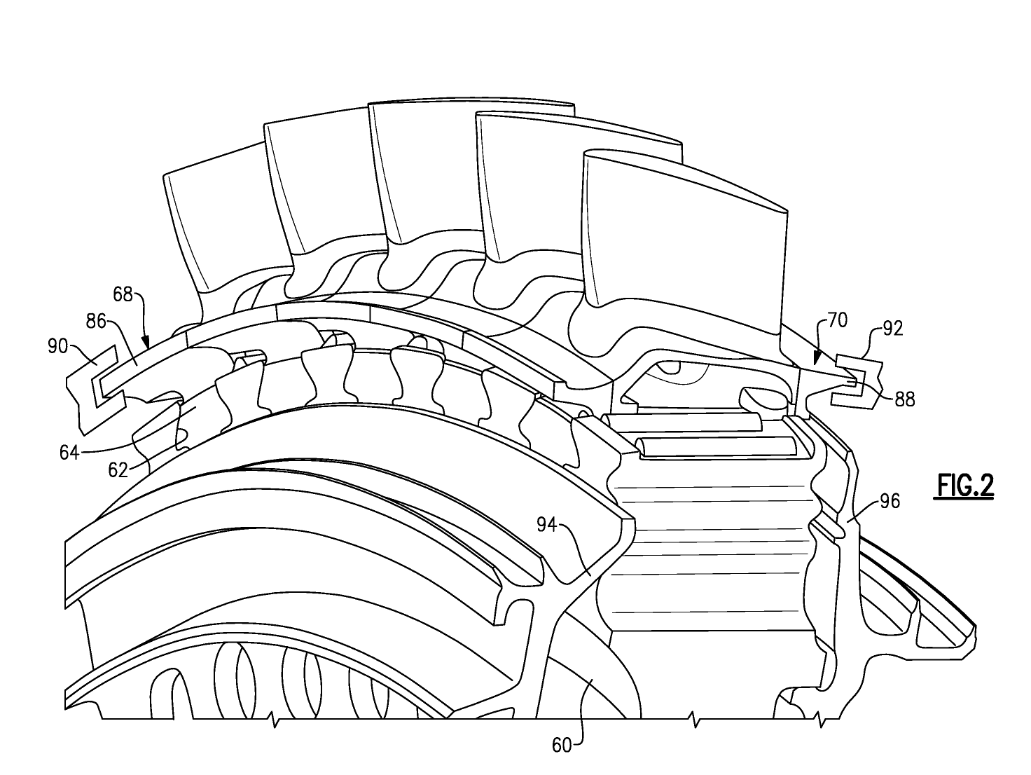

An example turbine stage is illustrated in FIG. 2. The stage includes a rotor 60 having multiple slots 62 circumferentially arranged about an outer perimeter of the rotor 60. A multi-piece blade assembly is provided, which is mounted within each slot 62. In the example, one piece provides a rim seal 64 and another piece provides a blade 76, which is a turbine blade in the example. The rim seal 64 and blade 76 are constructed from metallic alloys. The rim seal 64 and blade 76 slide together as an assembly into the slot 62 of the rotor 60 during installation.

The rim seal 64 is provided by leading and trailing edge seal portions 68, 70 that are axially spaced apart from one another to provide a notch 66, or gap, between the portions, best shown in FIG. 4. In the example, an axial portion 72 is integral with and interconnects the leading and trailing edge seal portions 68, 70 to provide a unitary, cast structure that forms a cradle that receives the blade 76. The axial portion 72 and leading and trailing edge seal portions 68, 70 may be discrete components secured to one another, if desired. The rim seal 64 may be constructed from any suitable material for the given application. The leading and trailing edge seal portions 68, 70 provide inner axial surfaces 74 that are spaced apart from and face one another. The blade 76 includes spaced apart outer axial surfaces 84 that are adjacent to and engage the inner axial surfaces 74 with the blade 76 received in the notch 66. The integral arrangement of the rim seal 64 maintains tight clearances between the inner and outer axial surfaces 74, 84, which minimize leakage through the stage.

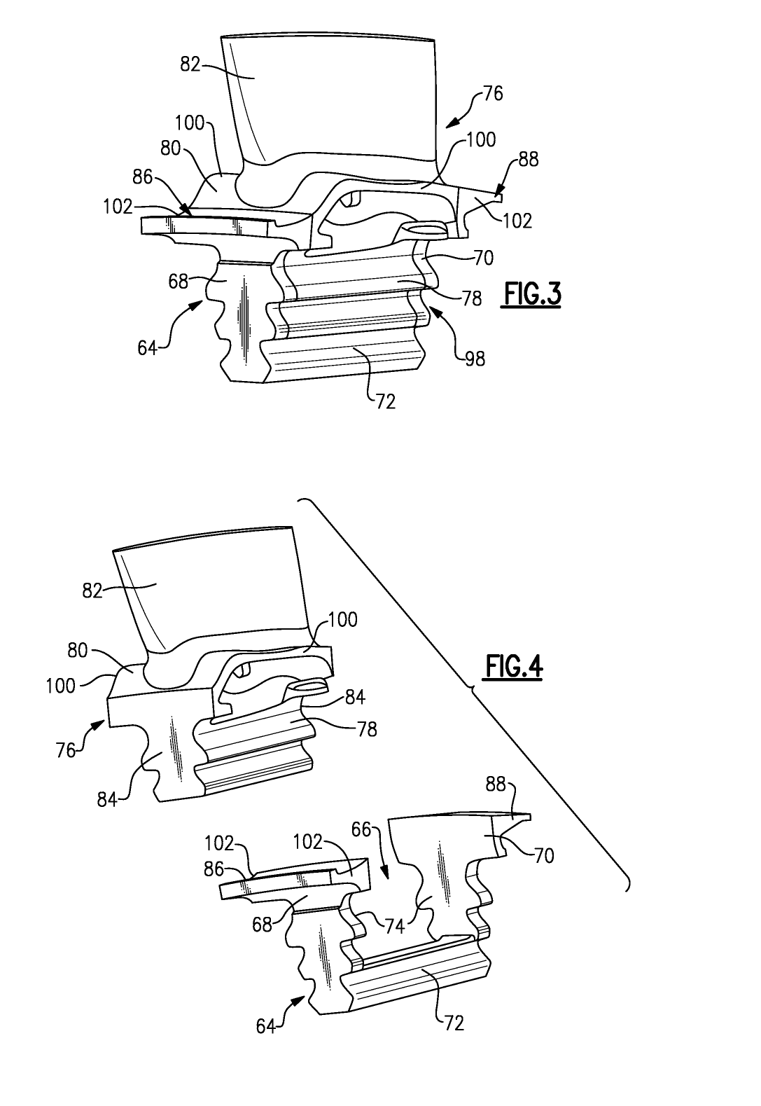

The blade 76 is received in the notch 66 of the rim seal 64, as shown in FIG. 3. The blade 76 includes a root 78 that together with the rim seal 64 provides a root contour 98 having a shape corresponding to the shape of the slot 62. In the example, the root contour 98 corresponds to a firtree shape.

The blade 76 includes a platform 80 that supports an airfoil 82, which extends radially outward from the platform 80. The platform 80 together with outer surfaces of the leading and trailing edge seal portions 68, 70 provide an inner flow path through the stage.

The leading and trailing edge seal portions 68, 70 respectively provide forward and aft seal geometries 86, 88. Referring to FIG. 2, the forward and aft seal geometries 86, 88 cooperate with forward and aft seal structures 90, 92 to provide an air seal along the inner flow path. Forward and aft retainers 94, 96 are secured to the rotor 60 to retain the rim seal 64 and blade 76 axially within the slots 62.

The blade 76 and rim seal 64 respectively include circumferential edges 100, 102 that adjoin and align with one another in the assembled position with the rim seals and blades 64, 76 installed in the rotor 60. In the example, the circumferential edges 100, 102 are generally in the same plane as one another. The rim seal 64 does not circumscribe the airfoil 82.

Having a rim seal 64 that is separate from the blade 76 enables the seal geometry to be more easily changed without creating new blades 76, which is a complex and expensive component to manufacture. However, the platform 80 and root 78 remains a unitary, cast structure with the airfoil 82 to provide a structurally robust design.

Although an example embodiment has been disclosed, a worker of ordinary skill in this art would recognize that certain modifications would come within the scope of the claims. For that reason, the following claims should be studied to determine their true scope and content.

What is claimed is:

1. A blade assembly for a gas turbine engine comprising:
a rim seal including leading and trailing edge seal portions joined to one another by an axial portion, the leading and trailing edge seal portions and the axial portion together providing a notch; and
a blade having a root received in the notch.

2. The blade assembly according to claim 1, wherein the blade has a first circumferential edge, and the rim seal has a second circumferential edge, the first and second circumferential edges aligned with one another in generally the same plane.

3. The blade assembly according to claim 1, wherein the rim seal and the blade root together provide a root contour.

4. The blade assembly according to claim 1, wherein the rim seal and the blade together provide a platform defining an inner flow path.

5. The blade assembly according to claim 1, wherein the blade includes an airfoil extending from the platform, wherein the rim seal does not circumscribe the airfoil.

6. The blade assembly according to claim 1, wherein the axial portion is arranged beneath the root opposite the airfoil.

7. The blade assembly according to claim 1, wherein the rim seal and blade are constructed from metallic alloys.

8. The blade assembly according to claim 1, wherein the axial portion and the leading and trailing edge seal portions are integral with one another.

9. The blade assembly according to claim 1, wherein the axial portion and the leading and trailing edge seal portions are discrete from and secured to one another.

10. A rotating stage of a gas turbine engine, comprising:
a rotor including a slot;
a rim seal including leading and trailing edge seal portions adjoined to one another by an axial portion and providing a notch; and
a blade having a root received in the notch.

11. The rotating stage according to claim 10, comprising a retainer secured to the rotor configured to maintain the rim seal and blade within the slot.

12. The rotating stage according to claim 10, comprising a seal structure adjacent to the rim seal, the rim seal including seal geometry interleaved with the seal structure.

13. The rotating stage according to claim 10, wherein the blade has a first circumferential edge, and the rim seal has a second circumferential edge, the first and second circumferential edges aligned with one another in generally the same plane.

14. The rotating stage according to claim 10, wherein the rim seal and the blade root together provide a root contour, the rim seal and the blade together provide a platform defining an inner flow path, the blade includes an airfoil extending from the platform, the rim seal does not circumscribe the airfoil, and the axial portion is arranged beneath the root opposite the airfoil.

15. The rotating stage according to claim 10, wherein the axial portion and the leading and trailing edge seal portions are integral with one another.

16. The rotating stage according to claim 10, wherein the axial portion and the leading and trailing edge seal portions are discrete from and secured to one another.

17. A method of assembling a rotor stage comprising:
inserting a root of a blade into a notch of a rim seal; and
sliding the rim seal and blade into a rotor slot.

18. The method according to claim 17, comprising securing a retainer to the rotor to abut the rim seal.

19. The method according to claim 17, comprising arranging a seal geometry of the rim seal in an interleaved relationship with a seal structure.
